(19) United States
(12) Patent Application Publication
(10) Pub. No.: US 2026/0042896 A1
(43) Pub. Date: Feb. 12, 2026

(54) VITRIMERIZATION OF POLYURETHANE

(71) Applicant: CASE WESTERN RESERVE UNIVERSITY, Cleveland, OH (US)

(72) Inventors: Ica Manas-Zloczower, Cleveland, OH (US); Alireza Bandeg, Cleveland, OH (US)

(21) Appl. No.: 19/099,500

(22) PCT Filed: Aug. 1, 2023
(86) PCT No.: PCT/US2023/029225

§ 371 Date: Jan. 29, 2025

Related U.S. Application Data
(60) Provisional application No. 63/394,122, filed on Aug. 1, 2022.

(51) Int. Cl. C08J 11/28

(52) U.S. Cl. CPC C08J 11/28; C08J 2375/04

(57) ABSTRACT

A vitrimerized polymer composition includes a polyurethane with partially broken down crosslinking ligands, a catalyst, and a dynamic recyclable network in which a portion of the catalyst forms ligands with a portion of the polyurethane.

### RELATED APPLICATION

This application claims priority from U.S. Provisional Application No. 63/394,122 filed Aug. 1, 2022, the subject matter of which is incorporated herein by reference in its entirety.

### BACKGROUND

Polyurethane (PU) thermosets are extensively used in different applications, such as furniture, construction, automobile, sound, and thermal insulation. Polyurethanes are versatile materials used as adhesives, coatings, elastomers, and foams. The growing quantities of PU thermoset waste causes significant environment challenges and consequently technologies to recycle the thermoset PUs have attracted significant attention. However, the recycling of thermoset PUs is limited due to their permanent crosslinked structure which prevents melt reprocessing. Common methods for recycling these materials are mechanical recycling and chemical degradation. In the mechanical approach, the materials are crushed and used as filler in other applications. However, using these recyclates as fillers above certain limits decreases the mechanical properties and prevent processing because of the increased viscosity of the compound. In the chemical approach, the PU thermosets are recycled into polyols or other small molecules via catalyzed glycolysis. Both these methods have low efficiency and high energy requirements. Therefore, it is essential to design a practical and efficient method for recycling PU thermoset wastes directly into similar or higher-value products.

### SUMMARY

Embodiments described herein relate to methods for recycling heretofore unprocessable thermoset polyurethane through the careful selection of materials and processing conditions. Polyurethane (PU) thermosets are extensively used in different applications and recycling large amounts of PU thermoset waste remains a universal challenge. We found that organocatalysts, such as triazabicyclodecene (TBD), can be used in a vitrimerization process to recycle and reprocess thermoset rigid PU foams. The results show that the permanent crosslinked structure of the PU thermoset foam is converted to a dynamic network upon vitrimerization. The vitrimerized network can rapidly relax the stress in 10 seconds at temperatures as low as 120° C. The topology rearrangement happens through the carbamate exchange reaction, mainly via a dissociative mechanism. The vitrimerized network retains high mechanical strength with Young's Modulus of 2.7 GPa and tensile strength of 76.4 MPa and can be reprocessed for a second time without addition of extra catalyst and without loss in mechanical properties. The vitrimerized network can also be foamed by applying small pressure at high temperatures. Advantageously, the processing conditions do not require the handling or use of solvents, thereby representing a significant improvement over approaches in which catalysts are dissolved in a solution so as to induce swelling in the thermoset and expedite the overall recycling process.

In some embodiments, a method for recycling polyurethane includes partially breaking down crosslinking ligands in the polyurethane. A catalyst is provided to the broken down polyurethane to create a recycling vitrimer polyurethane composition. The vitrimer polyurethane composition is then processed into vitrimerized polyurethane, wherein the vitrimerized polyurethane includes a dynamic recyclable network in which a portion of the catalyst forms ligands with a portion of the polyurethane.

In other embodiments, a method for recycling polyurethane includes partially, mechanically breaking down crosslinking structure in the polyurethane. A catalyst is mechanically mixed with the broken-down polyurethane to create a recycling vitrimer polyurethane composition. The vitrimer polyurethane composition is then thermally and/or mechanically processed into vitrimerized polyurethane product, wherein the vitrimerized polyurethane product includes a dynamic recyclable network in which a portion of the catalyst forms ligands with a portion of the polyurethane, through carbamate exchange reaction.

In still other embodiments, a method for recycling a thermoset polyurethane foam, includes selecting a thermoset polyurethane foam provided as particles and/or fragments. A catalyst is provided to the particles of thermoset polyurethane foam to create a recycling vitrimer polyurethane composition. The recycling vitrimer polyurethane composition is milled in the presence of a milling media into vitrimer polyurethane. The vitrimer polyurethane includes a dynamic recyclable network in which a portion of the catalyst forms ligands with a portion of the polyurethane.

In some embodiments, the selected thermoset polyurethane foam is waste thermoset polyurethane foam.

In some embodiments, the catalyst is provided at less than 15.0 wt. % of a mass of the recycling vitrimer polyurethane composition. For example, the catalyst can be provided at about 5.0 wt. % to about 10 wt. % of a mass of the recycling vitrimer polyurethane composition.

In some embodiments, the catalyst includes an eco-friendly organic catalyst, such as triazabicyclodecene.

In some embodiments, the recycling vitrimer polyurethane composition is formed as a fine powder.

In some embodiments, the method further includes reprocessing the vitrimer polyurethane to form a recycled article. The vitrimer polyurethane can be reprocessed by heating the vitrimer polyurethane at a temperature below the melting temperature of the catalyst. For example, the vitrimer polyurethane can be reprocessed by compression molding the vitrimer polyurethane at a temperature below the melting temperature of the catalyst.

In some embodiments, the method can further include heating the recycled article to a temperature and a pressure effective to foam the recycling vitrimer polyurethane composition. The temperature effective to foam the recycling vitrimer polyurethane composition can be greater than the melting temperature of the catalyst.

In other embodiments, the recycled article can be reprocessed for a second time without addition of catalyst and without loss in mechanical properties.

Other embodiments relate to a recycled polyurethane formed by a method described herein. The recycled polyurethane can be configured to be reprocessed without addition of additional catalyst and without loss in mechanical properties.

Other embodiments relate to a vitrimerized polymer composition that includes a polyurethane with partially broken down crosslinking ligands and a catalyst, wherein the vitrimerized polymer composition includes a dynamic recyclable network in which a portion of the catalyst forms ligands with a portion of the polyurethane.

Still other embodiments relate to a vitrimerized polymer composition that includes a polyurethane with partially broken down crosslinking ligands and an eco-friendly organocatalyst, wherein: the vitrimerized polymer composition includes a dynamic recyclable network in which a portion of the catalyst forms ligands with a portion of the polyurethane; and/or the vitrimerized polymer composition network can rapidly relax stress, preferably in 10 seconds, at a low temperature, preferably less 120° C.; and/or the vitrimerized polymer composition network retains high mechanical strength, preferably with Young's Modulus of at least 2.7 GPa and tensile strength of at least 76.4 MPa.

Still other embodiments relate to a vitrimerized polymer composition that includes a polyurethane with partially broken down crosslinking ligands, a catalyst, and a dynamic recyclable network in which a portion of the catalyst forms ligands with a portion of the polyurethane.

In some embodiments, the catalyst is provided at less than 15.0 wt. % of a mass of the composition. For example, the catalyst can be provided at about 5.0 wt. % to about 10 wt. % of a mass of the composition.

In some embodiments, the catalyst includes triazabicyclodecene.

In some embodiments, the vitrimerized polymer composition can be in the form of a fine powder.

In some embodiments, the polyurethane is a thermoset polyurethane foam.

In some embodiments, the vitrimerized polymer composition can be processed into an article. The article can be, for example, a compression molded article and/or a foamed article.

In some embodiments, the article can have at least one of a Young's modulus (GPa) greater than the thermoset polyurethane foam, a tensile strength (MPa) greater than the thermoset polyurethane foam, or an elongation at break (%) less than the thermoset polyurethane foam.

In some embodiments, the article or vitrimerized polymer composition can be reprocessed without addition of catalyst and without loss in mechanical properties.

### BRIEF DESCRIPTION OF THE DRAWINGS

FIG. 1 illustrates a method for recycling a thermoset polyurethane foam by vitrimerization.

FIG. 2 is a schematic representing the dissociative and associative mechanisms during the carbamate exchange reaction.

FIG. 3 illustrates FTIR spectra of initial and vitrimerized PU foam with different concentrations of catalyst.

FIGS. 4(A-D) illustrate (A) Storage modulus and (B) Tan δ of vitrimerized networks. (C) DSC curves, and (D) TGA curves of weight loss.

FIGS. 5(A-D) illustrate (A,B) Stress relaxation curves of vitrimerized samples at different temperatures for 2, and 10 wt. % TBD, (C) Arrhenius plot of the relaxation times at various temperatures, (D) Dilatometry results for vitrimerized network.

FIGS. 6(A-D) illustrate (A) Foaming the vitrimerized network by applying pressure and heating at 170° C. Cross section SEM images of (B) Initial PU foam, (C) Vitrimerized network with 10 wt. % TBD, and (D) Foam produced from vitrimerized network with 10 wt. % TBD.

FIG. 7 illustrates strain-stress curves of vitrimerized PU foams.

FIGS. 8(A-B) illustrate images showing preheating of samples for 10 minutes at (A) 120° C. and (B) 200° C.

FIG. 9 illustrates images of vitrimerized networks converted to foam at elevated temperature during DMA analysis.

FIG. 10 illustrates stress-strain curve for the initial PU foam.

### DETAILED DESCRIPTION

While specific embodiments are identified, it will be understood that elements from one described aspect may be combined with those from a separately identified aspect. In the same manner, a person of ordinary skill will have the requisite understanding of common processes, components, and methods, and this description is intended to encompass and disclose such common aspects even if they are not expressly identified herein.

As used herein, the words “example” and “exemplary” mean an instance, or illustration. The words “example” or “exemplary” do not indicate a key or preferred aspect or embodiment. The word “or” is intended to be inclusive rather than exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise.

Embodiments described herein relate to methods for recycling heretofore unprocessable thermoset polyurethanes, such as rigid thermoset polyurethane foams, through the careful selection of materials and processing conditions. Polyurethane (PU) thermosets are extensively used in different applications and recycling large amounts of PU thermoset waste remains a universal challenge. We found that organocatalysts, such as triazabicyclodecene (TBD), can be used in a vitrimerization process to recycle and reprocess thermoset rigid PU foams. The results show that the permanent crosslinked structure of the PU thermoset foam is converted to a dynamic network upon vitrimerization. The vitrimerized network can rapidly relax the stress in 10 seconds at temperatures as low as 120° C. The topology rearrangement happens through the carbamate exchange reaction, mainly via a dissociative mechanism. The vitrimerized network retains high mechanical strength with Young's Modulus of 2.7 GPa and tensile strength of 76.4 MPa and can be reprocessed for a second time without addition of extra catalyst without loss in mechanical properties. The vitrimerized network can also be foamed by applying small pressure at high temperatures. Advantageously, the processing conditions do not require the handling or use of solvents, thereby representing a significant improvement over approaches in which catalysts are dissolved in a solution so as to induce swelling in the thermoset and expedite the overall recycling process.

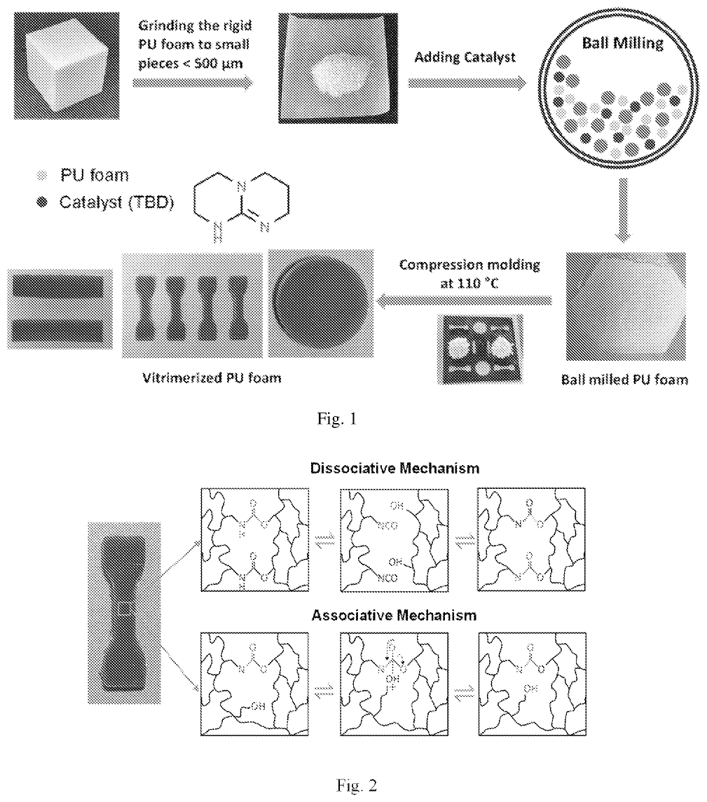

FIG. 1 illustrates a method for recycling a rigid thermoset polyurethane foam by vitrimerization. The rigid PU foam is first ground into small pieces and mixed with vitrimerization catalyst particles in a suitable mill, such as a rotating drum with steel balls and/or other appropriate media. The rotational movement ensures that the milling media (black circles representing steel balls) is intimately mixed with rigid PU foam particulates and catalyst particles. The rotation both promotes mixing and, owing to the collisions between particles, particulates, and/or the milling media, crushes and reduces the size of the particulates and forms metal-polymeric ligand sites. While a rotating drum is schematically illustrated, any conventional milling apparatus may suffice, while the steel balls may be replaced or augmented by other common milling media (provided that the milling media itself does not disintegrate or otherwise introduce unwanted materials). The milling media must be sufficiently durable to grind and pulverize the particles and particulates and impart the energy required to form the metal-polymeric ligand sites.

A catalyst can be chosen based on the chemistry of the thermoset polyurethane network. The catalyst should be chosen such as to have a sufficiently high degradation temperature to minimize deactivation/loss of the material under the expected milling conditions. In some embodiments, triazabicyclodecene (TBD) can be used as a catalyst for vitrimerization of the thermoset polyurethane foam. The catalyst may also be chosen from catalysts of organic nature, such as but not limited to, benzyldimethylamide, and benzyltrimethylammonium chloride. Other non-limiting examples of the catalyst may include: tin(II) 2-ethylhexanoate, zinc(II) acetate (Zn(OAc)₂), triphenylphosphine (PPh₃), dibutyltin bis(2-ethylhexanoate), dibutyltin diacetate, dibutyltin dilaurate, dibutyltin bis(2,4-pentanedionate), titanium 2-ethylhexanoate, monobutyltin oxide, and zinc octoate.

The catalyst can be utilized in an amount sufficient to produce a vitrimer having desired properties. Specific, non-limiting amounts of catalyst that have been found effective include 2 wt. %, 5 wt. %, and 10 wt. % of catalyst per mixture to be milled (i.e., thermoset PU, and catalyst combined). Thus, the catalyst may be provided at less than 8.0 wt. %, less than 9.0 wt. %, less than 10.0 wt. %, or less than 15 wt. % and any range of values bounded by these upper and lower limits. For example, the catalyst can be provided at about 1 wt. % to less than 15 wt. %, about 1 wt. % to about 14 wt. %, about 1 wt. % to about 13 wt. %, about 1 wt. % to about 12 wt. %, about 1 wt. % to about 11 wt. %, about 1 wt. % to about 10 wt. %, about 2 wt. % to about 14 wt. %, about 3 wt. % to about 14 wt. %, about 4 wt. % to about 14 wt. %, about 5 wt. % to about 14 wt. %, about 3 wt. % to about 13 wt. %, about 4 wt. % to about 12 wt. %, or about 5 wt. % to about 10 wt. % of the recycling composition. Advantageously, the amount of catalyst should be minimized or at least selected to balance against processing times and costs (as the catalyst may be more expensive to procure than the thermoset waste material).

By action of the milling, the catalyst becomes intimately mixed with the small pieces of thermoset polyurethane waste. The waste (and, possibly, the catalyst) are reduced in size in order to generate fine powder mixture at 100% yield. This procedure called “vitrimerization” generates vitrimerized polyurethane, which can be reprocessed.

Fine powder will be understood to describe the comparative particle size. Powder is significantly smaller in average particle size and distribution in comparison to grinding. Both techniques are known in the art.

More specifically, fine powders are particles that flow freely when poured. In some aspects, substantially all of the material passes through a at least a no. 355 and/or a no. 180 sieve (i.e., both as per ISO standard 565-1972), meaning that substantially all particulates are smaller than the respective aperture sizes of 0.355 mm and/or 0.180 mm found respectively in such sieves.

FIG. 1 further shows representations of the fine powder mixture and a hot pressing or compression molding procedure which can used to form the powder mixture into recycled components or articles. These steps are subsequent to formation of the catalyst-ligand complex that enables recycling of the powder created.

The vitrimer polyurethane can be reprocessed by heating the vitrimer polyurethane at a temperature below the melting temperature of the catalyst. For example, the vitrimer polyurethane can be reprocessed by compression molding the vitrimer polyurethane at a temperature below the melting temperature of the catalyst.

FIG. 2 shows the exchange reaction in the urethane linkage can occur through associative and dissociative mechanisms. The rapid drop in viscosity due to the dissociative exchange reaction increases the efficiency of reprocessing. However, the dissociative mechanism creates free isocyanate groups which can result in secondary reactions and stable byproducts that can reduce the dynamic character of the network.

Notably, once the vitrimer-type polymer is formed, it can be reprocessed and recycled without adding more catalyst. Dynamic analysis, including the data below, indicates the vitrimer-type polymer exhibits comparable characteristics to the original/“virgin” thermoset polyurethane foam material. In some embodiments, vitrimer polyurethane or an article that includes the vitrimer polyurethane can have at least one of a Young's modulus (GPa) greater than the thermoset polyurethane foam, a tensile strength (MPa) greater than the thermoset polyurethane foam, or an elongation at break (%) less than the thermoset polyurethane foam.

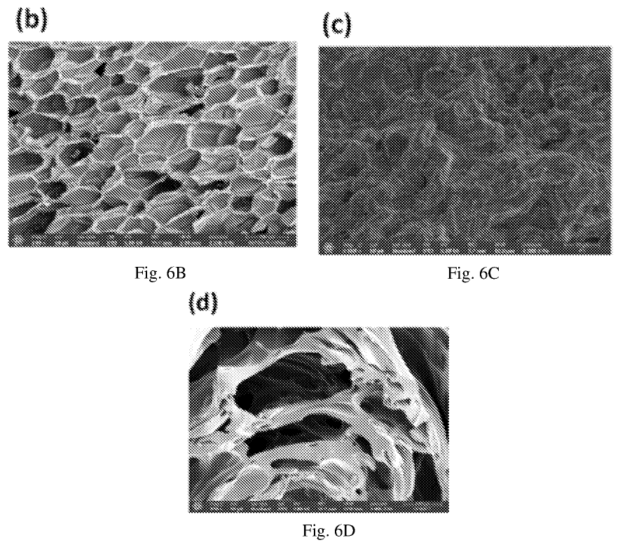

In some embodiments, the method can further include heating the recycled article to temperature and pressure effective to foam the vitrimer polyurethane. The temperature effective to foam the vitrimer polyurethane can be greater than the melting temperature of the catalyst. For example, FIG. 6A shows that by applying 10 N force at temperature of 170° C. foaming occurs in the vitrimerized network. The SEM images show that the initial foam has cell size around 250 micrometer and the cell size for the foam produced from the vitrimerized network is in the range of 200 to 500 micrometer. Further optimization will allow tailoring the density and cell structure of the foam.

Advantages of the disclosed method include the elimination of any solvents. Further, ball milling can be achieved at low temperatures (i.e., without the need for providing external sources of heat and typically lower than 300° C. or less). Milling operations can be engineered to incorporate batch or continuous feed processes, with the latter requiring material feed rates to be controlled in combination with the milling conditions to ensure sufficient resident time is achieved in the mill, with gravity-induced inclines, rotation of the milling chamber, and/or release valves providing further measures of control.

### Example

This example describes an efficient method for recycling rigid PU thermoset foam wastes to high value-added products. The method uses a carbamate exchange reaction for the vitrimerization of thermoset rigid PU foams. Vitrimerization is a feasible, cost effective, environment-friendly, and commercially scalable process that can pave the way for thermoset recycling. An organocatalyst, such as triazabicyclodecene (TBD), was used for the vitrimerization of the rigid PU foams. TBD is in a solid state at room temperature enabling its use in a mechanochemical process. We explored the effect of different catalyst concentrations on the mechanisms of exchange reactions (associative and dissociative) and on the final properties of vitrimerized network.

### Materials

Commercial rigid polyurethane foam was kindly provided by Stepan Company. The Triazabicyclodecene (TBD) was purchased from Sigma-Aldrich and used as catalyst.

### Vitrimerization Process

The fine particles (<500 μm) of the polyurethane foams were obtained by grinding the small pieces of PU foams. The ultrafine powder mixtures were obtained by ball milling the PU fine particles and the catalyst (TBD) in a ball mill tank (Fritsch pulverisette 6), purged with N₂. Each run for the ball milling process was for 45 minutes with 8 cycles of grinding for 5 minutes at a speed of 570 rpm and intermediate cooling for 15 minutes. The compression molding of the ball milled powder mixtures were performed at 110° C. and 20 MPa with 10 min preheating and 60 min heating in a mold, to obtain vitrimerized samples (FIG. 1). Reprocessing of the vitrimerized samples was performed with the same procedure except that no catalyst was added during the ball milling.

### Characterization

### Dynamic Mechanical Analysis

TA Instruments Q800 was used to measure the dynamic mechanical properties, storage modulus (E′), and tan (δ). The measurements were performed in tensile mode with a strain amplitude of 0.05% at constant frequency of 1 Hz and scanning rate of 5° C. min⁻¹ from 25 to 200° C. The glass transition temperature (T_{g}) of samples were determined by the peak of tan (δ) curves. Dilatometry was performed in tension and controlled force mode. Two different constant forces of 0.2 and 0.75 N were used with a heating rate of 5° C. min⁻¹ from 25 to 200° C. The strain was measured during the test.

### Fourier Transform Infrared Spectroscopy (FTIR)

FTIR analyses were carried out using an Agilent Cary 630 FTIR spectrophotometer in a spectral range of 4000-600 cm-1.

### Mechanical Testing

Stress-strain curves were obtained on an MTS Insight tensile instrument in tensile mode. The samples size was 1.2 mm×5.4 mm×15 mm (thickness, width, gage length) and the strain rate was 5 mm min⁻¹.

### Rheology

Stress relaxation tests were performed on a TA ARES-G2 rheometer with a 25 mm parallel plate geometry on samples with average thickness of 1.2 mm. After a 10 min temperature equilibrium, a 0.1% strain strep was applied. A constant normal force of 10 N was applied during the test to avoid the gap between the sample and geometry.

### Thermogravimetric Analysis (TGA)

TA Instruments Q500 with an aluminum pan was used to study the thermal stability. Around 10 mg was used for each run with a heating rate of 10° C. min⁻¹ from room temperature to 700° C. under nitrogen flow.

### Scanning Electron Microscopy (SEM)

ThermoFisher Apreo2 SEM Scanning Electron Microscope was used to characterize the morphology of the PU foams and vitrimerized samples.

### Results and Discussion

### Network Reforming

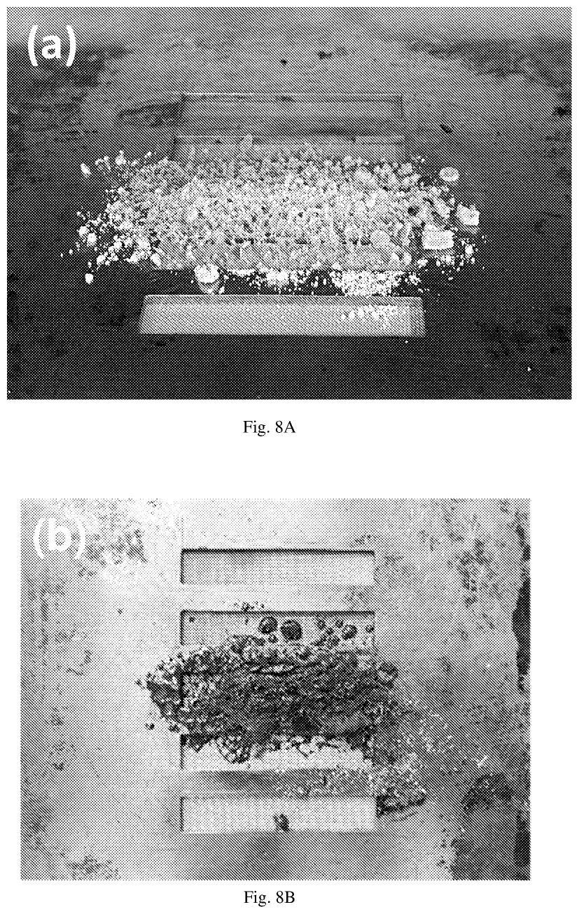

The vitrimerization process is shown schematically in FIG. 1. The mixture of grinded PU foam and different concentrations of catalyst (2, 5, and 10 wt. %) are ball milled under nitrogen atmosphere. It should be noted that the melting temperature of the TBD is 125° C., therefore, to avoid the catalyst melting during the compression molding as illustrated by preheating the powders at 120° C. (FIG. 8A), the powders were vitrimerized at 110° C. Increasing the temperature to 200° C. for the ball milled powder with catalyst results in sample degradation during compression molding (FIG. 8B).

As shown in FIG. 2, the exchange reaction in the urethane linkage can occur through associative and dissociative mechanisms. The rapid drop in viscosity due to the dissociative exchange reaction increases the efficiency of reprocessing. However, the dissociative mechanism creates free isocyanate groups which can result in secondary reactions and stable byproducts that can reduce the dynamic character of the network.

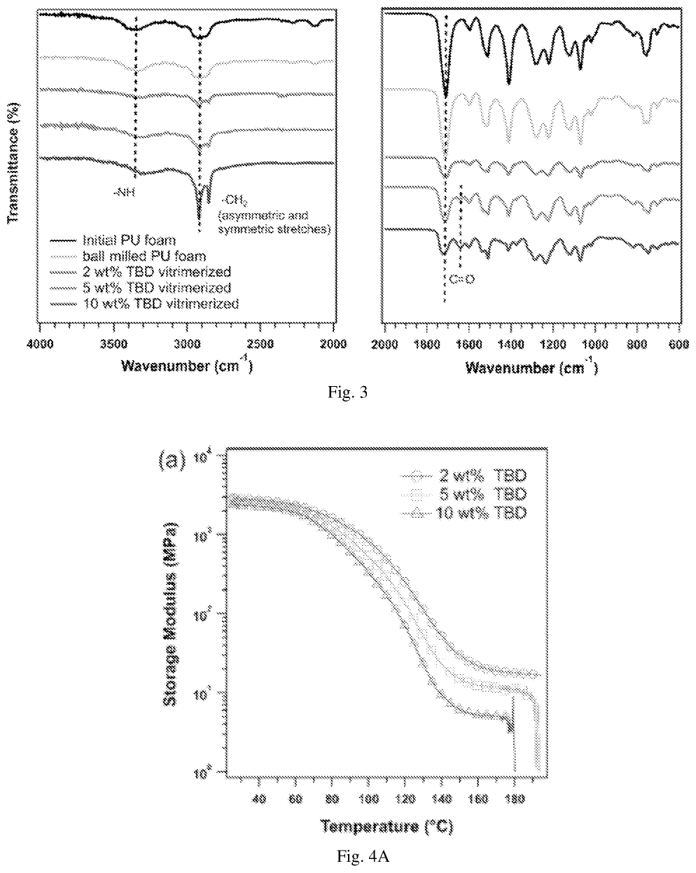

The FTIR results for the initial, vitrimerized and ball milled PU foams (FIG. 3) show that by introducing the catalyst and increasing the concentration to 5 and 10 wt. % there is a split for the absorbance of the urethane carbonyl groups (C═O) in 1718 and 1650 cm⁻¹. This spitted absorbance has been attributed to the stretching vibrations of the non-hydrogen-bonded and hydrogen-bonded carbonyl groups. It has been shown that the carbonyl stretching vibration can shift to the absorbance of tens of cm⁻¹ in the lower wavenumber direction of spectrum due to the hydrogen bonding. In addition, the absorbance at around 3340 cm⁻¹ is related to the N—H stretching vibrations of the urethane groups and increasing the catalyst concentration results in hydrogen bonding of the N—H groups. The FTIR results show that increasing the catalyst concentration results in more hydrogen bonding in the structure of vitrimerized PU foams which can improve the mechanical properties of vitrimerized samples.

### Dynamic Mechanical Analysis

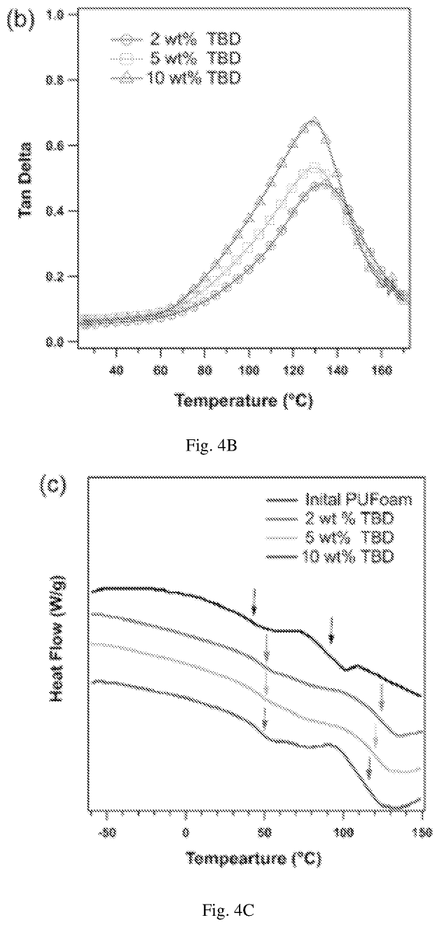

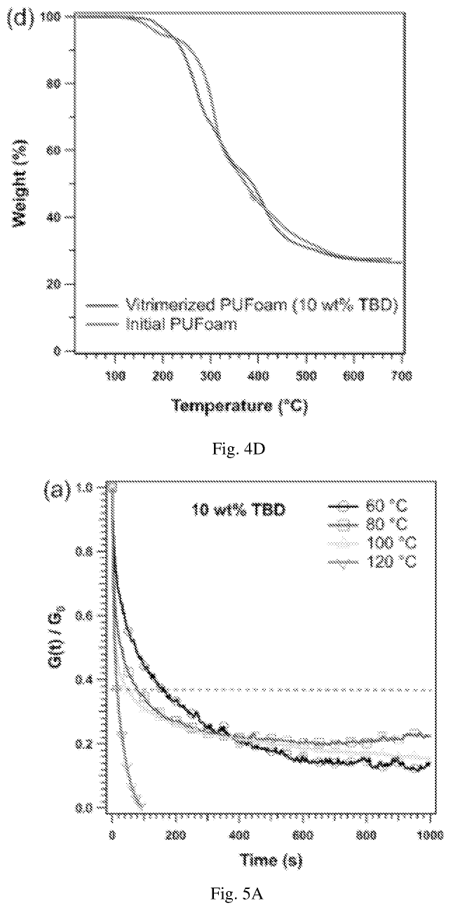

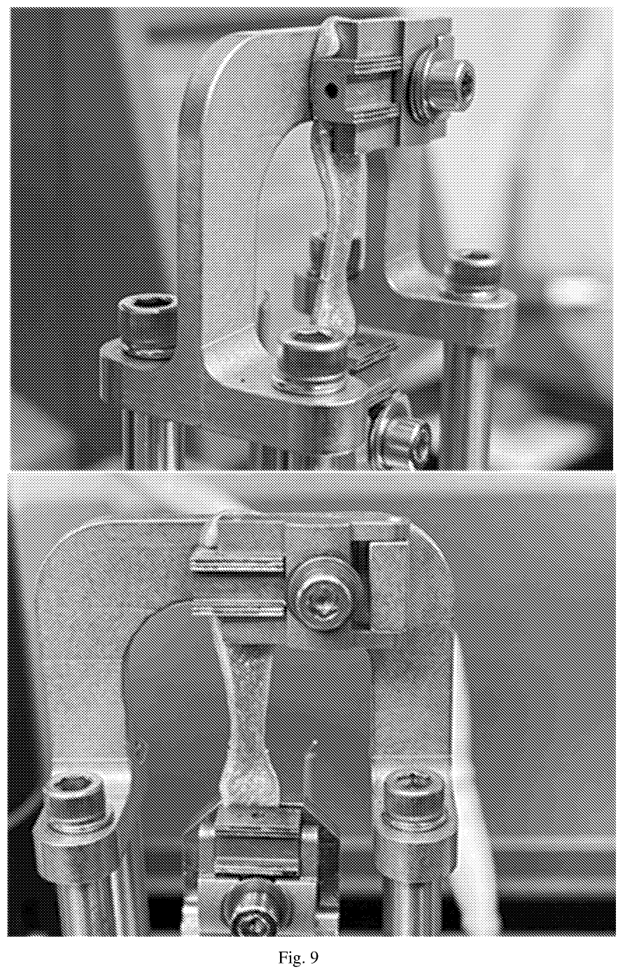

The DMA results (FIG. 4A) show similar values for the storage modulus of vitrimerized PU foams with different catalyst concentration at room temperature followed by an abrupt drop with increasing temperature and reaching a plateau region at elevated temperatures. The storage modulus at plateau region decreases with increasing the catalyst concentration in the vitrimerized samples suggesting primarily a dissociative mechanism for the exchange reaction. It should also be noted that at higher temperatures (around 170° C.) the vitrimerized samples with 5 and 10 wt. % catalyst exhibit an abrupt decay in storage modulus. As shown in FIG. 9, at this temperature these vitrimerized samples start foaming. This phenomenon may indicate the occurrence of side reactions of the free isocyanate groups. Such groups form potentially during the exchange reaction through a dissociative mechanism (FIG. 2).

### Thermal Properties of the Vitrimerized Networks

The thermal behavior of the vitrimerized networks was investigated and compared with the initial PU foam. The DSC results (FIG. 4C) show a weak transition around 50° C. which is not affected by the vitrimerization and a much sharper transition around 90° C. for the initial PU foam which shifts to higher temperatures (110-120° C.) for the vitrimerized samples. This second transition occurring at higher temperatures for the vitrimerized samples can be attributed to the higher crosslinked density in the vitrimerized networks. The DSC results show the same trend with the tan delta results presented in FIG. 4B and point out to a small reduction in glass transition temperature of the vitrimerized samples with increasing catalyst concentration. These results reiterate the plausible dissociative mechanism of exchange reaction at high temperatures increasing with catalyst concentration. The TGA results (FIG. 4D) show that the vitrimerized PU foams are stable up to 200° C., which is appropriate for most of the polyurethane-based material applications.

### Stress Relaxation

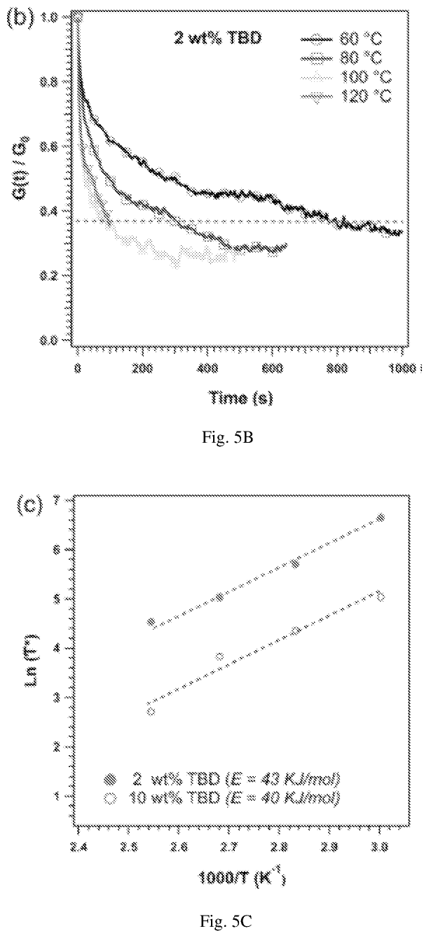

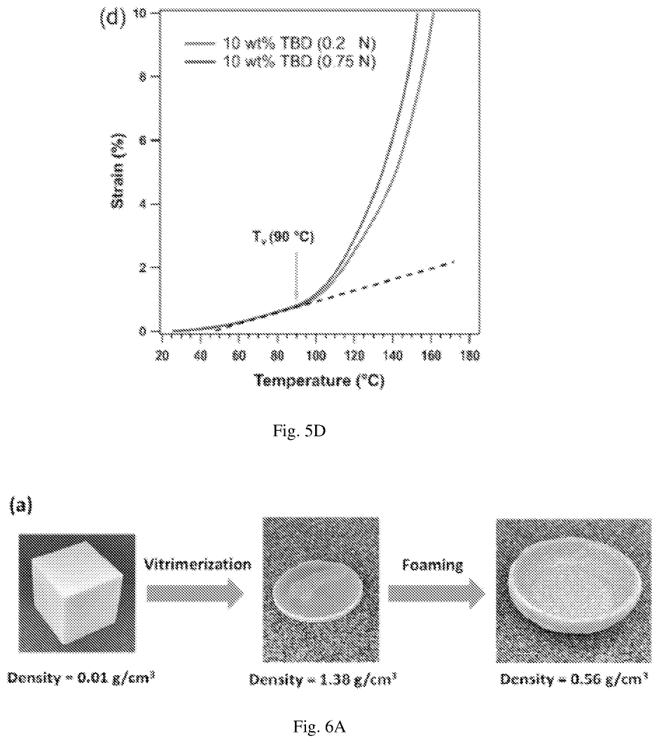

In the presence of catalyst, topology rearrangement and stress relaxation for the vitrimerized samples occur due to the exchange reactions, which are activated at elevated temperatures. As shown in FIGS. 5A and 5B, increasing the catalyst concentration accelerates the exchange reaction rate due to the formation of more dynamic linkages in the network. The Arrhenius equation τ*(T)=τ*₀((T) exp (Eₐ/RT) is used to obtain the activation energy (Ea) for the exchange reactions. The relaxation time τ* is defined as the time for relaxing 63% of the initial stress. The results show that the activation energy for the vitrimerized network with 2 wt. % catalyst is 43 KJ/mol and with 10 wt % TBD is 40 KJ/mol.

The dynamic covalent bonds in the vitrimerized network introduce a temperature-dependent behavior and the chemical exchange reactions control the viscosity. Therefore, the vitrimers can be processed without losing the network integrity due to the controlled viscosity by exchange reactions. The topology freezing point (Tᵥ) defines the viscoelastic phase transition in vitrimers. The exchange reaction happens slow and fast below and above the Tᵥ, respectively. The topology freezing point, measured in a dilatometry experiment performed using two different constant forces of 0.20 and 0.75 N to ensure reproducible results, is around 90° C. for the vitrimerized sample with 10 wt. % TBD (FIG. 5C).

### Foaming of Vitrimerized Network

As mentioned before, the vitrimerized network can be foamed again by applying heat and small pressure. FIG. 6A shows that by applying 10 N force at temperature of 170° C. foaming occurs in the vitrimerized network. The SEM images show that the initial foam has cell size around 250 micrometer and the cell size for the foam produced from the vitrimerized network is in the range of 200 to 500 micrometer. It should be noted that the work presented here for the foaming is an exploratory study and no process optimization was attempted. Further optimization will allow tailoring the density and cell structure of the foam.

### Mechanical Properties of Vitrimerized Network

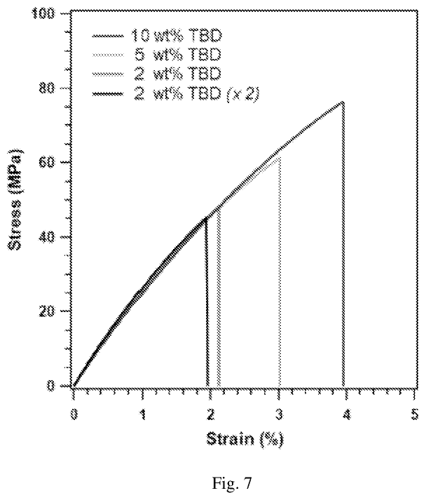

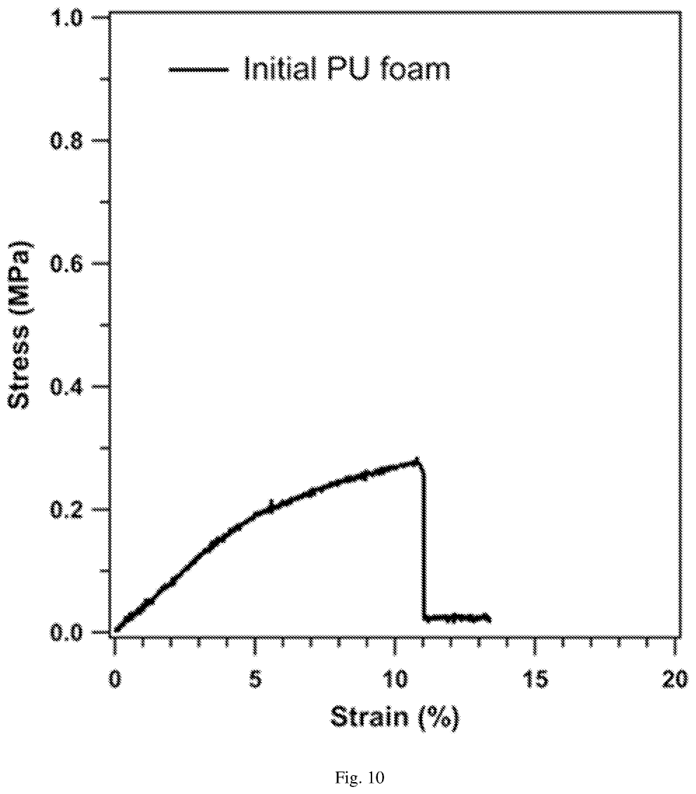

The mechanical properties of vitrimerized PU foam are evaluated by tensile tests, and the results are displayed in FIG. 7. Significantly more rigid networks are obtained upon vitrimerization (Young' Modulus≈2.7 GPa, tensile strength≈76.45 MPa for the sample with 10 wt. % TBD) compared to the initial PU foam (Young' Modulus≈4 KPa, tensile strength≈170 KPa). Details of mechanical properties are summarized in the Table below. As shown in FIG. 10, the tensile strength (σₘₐₓ) and elongation at break (ε_{b}) both increase with increasing the catalyst concentration, attributed to increased hydrogen bonding in the network at higher catalyst concentrations as revealed by the FTIR results (FIG. 3).

### Mechanical Properties of Initial PU Foam and Vitrimerized Samples.

| | | Young's | Tensile | Elongation at |
|---|---|---|---|---|
| Sample Code | | modulus [GPa] | strength [MPa] | break [%] |
| Initial PU foam | | 0.004 | 0.29 | 11.1 |
| 10 | wt % TBD | 2.70 | 76.45 | 3.95 |
| 5 | wt % TBD | 2.77 | 61.33 | 3.01 |
| 2 | wt % TBD | 2.71 | 47.81 | 2.12 |
| 2 | wt % TBD (×2) | 2.75 | 45.43 | 1.95 |

The vitrimerized network was reprocessed for the second time through grinding and ball milling without addition of any catalyst. The results (FIG. 7) indicate that the vitrimerized network can be reprocessed without loss in the mechanical properties.

Rigid polyurethane foams can be recycled through vitrimerization using an organocatalyst (TBD). Stress relaxation results show that the vitrimerized network can relax stress rapidly. The dynamic networks have low activation energy (as low as 40 KJ/mol for 10 wt. % TBD) which makes this vitrimerized material processable using common processing techniques such as injection molding and extrusion. The dynamic mechanical analysis indicates that the carbamate exchange reaction in the vitrimerized network is mainly occurring through a dissociative mechanism. The formation of free isocyanate during the exchange reaction at high temperatures (170° C.) and under small pressure results in foaming of the vitrimerized network. The mechanical properties of the vitrimerized network are significantly higher compared to previous reported values in the literature for recycled PU foams. The vitrimerization process shows potential for converting the rigid polyurethane foam waste already existing in the market into higher value-added products. This work can pave the way to overcome the challenges in recycling polyurethane thermoset waste and tune the properties of vitrimerized network with minimum environmental impact.

From the above description of the invention, those skilled in the art will perceive improvements, changes and modifications. Such improvements, changes and modifications within the skill of the art are intended to be covered by the appended claims. All references, publications, and patents cited in the present application are herein incorporated by reference in their entirety.

1. A method for recycling polyurethane, the method comprising:
partially breaking down crosslinking ligands in the polyurethane;
providing a catalyst to the broken down polyurethane to create a recycling vitrimer polyurethane composition; and
processing the recycling vitrimer polyurethane composition into vitrimerized polyurethane, wherein the vitrimerized polyurethane includes a dynamic recyclable network in which a portion of the catalyst forms ligands with a portion of the polyurethane.

2. The method of claim 1, wherein:
the crosslinking ligands are partially broken down by partially, mechanically breaking down crosslinking structure in the polyurethane;
the catalyst is mechanically mixed with the broken-down polyurethane to create the recycling vitrimer polyurethane composition;
the recycling vitrimer polyurethane composition is thermally and/or mechanically processed into the vitrimerized polyurethane; and
the portion of the catalyst forms ligands with the portion of the polyurethane, through carbamate exchange reaction.

3. The method of claim 2, wherein the polyurethane recycled is a thermoset polyurethane foam and the method further comprises selecting a thermoset polyurethane foam provided as particles and/or fragments prior to partially breaking down crosslinking ligands in the polyurethane.

4. The method of claim 1, wherein the catalyst is provided at less than 15.0 wt. % of a mass of the recycling vitrimer polyurethane composition.

5. The method of claim 4, wherein the catalyst comprises triazabicyclodecene.

6. The method of claim 1, wherein the recycling vitrimer polyurethane composition is formed as a fine powder.

7. The method of claim 3, further comprising reprocessing the vitrimer polyurethane to form a recycled article.

8. The method of claim 7, wherein the recycling vitrimer polyurethane composition is reprocessed by heating the recycling vitrimer polyurethane composition at a temperature below the melting temperature of the catalyst.

9. The method of claim 7, wherein the recycling vitrimer polyurethane composition is reprocessed by compression molding the recycling vitrimer polyurethane composition at a temperature below the melting temperature of the catalyst.

10. The method of claim 7, further comprising heating the recycled article to temperature and pressure effective to foam the recycling vitrimer polyurethane composition.

11. The method of claim 10, wherein the temperature effective to foam the vitrimer polyurethane is greater than the melting temperature of the catalyst.

12. The method of claim 7, wherein the recycled article is reprocessable for a second time without addition of catalyst and without loss in mechanical properties.

13. The method of claim 3, wherein the selected thermoset polyurethane foam is waste thermoset polyurethane foam.

14. A recycled polyurethane formed by a method of claim 1.

15. The recycled polyurethane of claim 14, wherein the recycled polyurethane is configured to be reprocessed without addition of additional catalyst and without loss in mechanical properties.

16. (canceled)

17. A vitrimerized polymer composition, comprising:
a polyurethane with partially broken down crosslinking ligands and an eco-friendly organocatalyst, wherein:
the vitrimerized polymer composition includes a dynamic recyclable network in which a portion of the catalyst forms ligands with a portion of the polyurethane; and/or
the vitrimerized polymer composition network can rapidly relax stress, preferably in 10 seconds, at a low temperature, preferably less 120° C.; and/or
the vitrimerized polymer composition network retains high mechanical strength, preferably with Young's Modulus of at least 2.7 GPa and tensile strength of at least 76.4 MPa.

18. (canceled)

19. The vitrimerized polymer composition of claim 17, wherein the catalyst comprises less than 15.0 wt. % of the vitrimerized polymer composition.

20. The vitrimerized polymer composition of claim 19, wherein the catalyst comprises triazabicyclodecene.

21. (canceled)

22. The vitrimerized polymer composition of claim 17, wherein the polyurethane is a thermoset polyurethane foam.

23. The vitrimerized polymer composition of claim 22, being processed into a foamed article.

24-28. (canceled)
